(19) United States
(12) Patent Application Publication
(10) Pub. No.: US 2025/0106726 A1
(43) Pub. Date: Mar. 27, 2025

(54) METHOD, DEVICE AND COMPUTER STORAGE MEDIUM OF COMMUNICATION

(71) Applicant: NEC CORPORATION, Tokyo (JP)

(72) Inventors: Da WANG, Beijing (CN); Lin LIANG, Beijing (CN); Gang WANG, Beijing (CN)

(73) Assignee: NEC CORPORATION, Tokyo (JP)

(21) Appl. No.: 18/832,797

(22) PCT Filed: Jan. 26, 2022
(86) PCT No.: PCT/CN2022/074114

§ 371 Date: Jul. 24, 2024

(51) Int. Cl. H04W 36/36

(52) U.S. Cl. CPC H04W 36/362

(57) ABSTRACT

Embodiments of the present disclosure relate to methods, devices and computer readable media for communication. A terminal device receives a set of configurations for a set of candidate cells. The terminal device determines a reference configuration, and applies, based on the reference configuration, a configuration for a candidate cell in the set of configurations. In this way, a delta configuration may be supported for subsequent conditional cell change or L1/L2 based mobility.

### TECHNICAL FIELD

Embodiments of the present disclosure generally relate to the field of telecommunication, and in particular, to methods, devices and computer storage media of communication for a radio resource control (RRC) configuration.

### BACKGROUND

Currently, a delta configuration is supported for signaling amount reduction and lossless transmission. For example, in case of a handover (HO), a source network device may transmit, to a target network device, a current RRC configuration in a HO request message, and the target network device may respond with a delta configuration with respect to the current RRC configuration. As another example, in case of primary cell (PScell) of a secondary node (SN) change, a master node (MN) may provide current secondary cell group (SCG) configuration of a source SN to a target SN in a SCG addition request message, and the target SN may only provide a delta configuration with respect to the current SCG configuration.

However, in case of a subsequent cell change, e.g., for a conditional cell change, a layer 1 (L1)/layer 2 (L2) based mobility or the like, the above delta configuration behavior may result in wrong configuration being applied by a terminal device or even reconfiguration failure. This is because the delta configuration is built on the basis of a source cell, but the delta configuration will be applied at a terminal device to a current serving cell changing during the subsequent cell change.

### SUMMARY

Embodiments of the present disclosure provide methods, devices and computer storage media of communication for a RRC configuration.

In a first aspect, there is provided a method of communication. The method comprises: receiving, at a terminal device and from a first network device, a set of configurations for a set of candidate cells; determining a reference configuration; and applying, based on the reference configuration, a configuration for a candidate cell in the set of configurations.

In a second aspect, there is provided a method of communication. The method comprises: receiving, at a terminal device and from a first network device, a set of configurations for a set of candidate cells; and in accordance with a determination that a cell change or addition to a candidate cell in the set of candidate cells is to be performed, applying a configuration for the candidate cell in the set of configurations, wherein the configuration for the candidate cell is the same as a configuration for a serving cell of the terminal device or a configuration for a further candidate cell in the set of candidate cells, except for at least one of the following: an identity for a candidate cell in the set of candidate cells; a timer for a candidate cell in the set of candidate cells; a dedicated random access channel configuration for a candidate cell in the set of candidate cells; or a measurement configuration of a candidate cell in the set of candidate cells.

In a third aspect, there is provided a method of communication. The method comprises: receiving, at a terminal device and from a first network device, a set of full configurations for a set of candidate cells; and in accordance with a determination that a cell change or addition to a candidate cell in the set of candidate cells is to be performed, applying a configuration for the candidate cell in the set of full configurations.

In a fourth aspect, there is provided a method of communication. The method comprises: transmitting, at a first network device and to a terminal device, a set of configurations for a set of candidate cells, and an indication indicating a configuration for one of a set of candidate cells as a reference configuration.

In a fifth aspect, there is provided a method of communication. The method comprises: transmitting, at a first network device and to a terminal device, a set of configurations for a set of candidate cells, wherein a configuration for a candidate cell in the set of candidate cells is the same as a configuration for a serving cell of the terminal device or a configuration for a further candidate cell in the set of candidate cells, except for at least one of the following: an identity for a candidate cell in the set of candidate cells; a timer for a candidate cell in the set of candidate cells; a dedicated random access channel configuration for a candidate cell in the set of candidate cells; or a measurement configuration of a candidate cell in the set of candidate cells.

In a sixth aspect, there is provided a method of communication. The method comprises: transmitting, at a first network device and to a terminal device, a set of configurations for a set of candidate cells, a configuration in the set of configurations being a full configuration for a candidate cell.

In a seventh aspect, there is provided a terminal device. The terminal device comprises a processor configured to cause the terminal device to perform the method according to any of the first to three aspects of the present disclosure.

In an eighth aspect, there is provided a network device. The network device comprises a processor configured to cause the network device to perform the method according to any of the fourth to sixth aspects of the present disclosure.

In a ninth aspect, there is provided a computer readable medium having instructions stored thereon. The instructions, when executed on at least one processor, cause the at least one processor to perform the method according to any of the first to three aspects of the present disclosure.

In a tenth aspect, there is provided a computer readable medium having instructions stored thereon. The instructions, when executed on at least one processor, cause the at least one processor to perform the method according to any of the fourth to sixth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram illustrating network protocol layer entities that may be established for a user plane (UP) protocol stack at devices according to some embodiments of the present disclosure;

FIG. 1C illustrates a schematic diagram illustrating network protocol layer entities that may be established for a control plane (CP) protocol stack at devices according to some embodiments of the present disclosure;

FIG. 1D illustrates a schematic diagram of a central unit (CU)/distributed unit (DU) architecture that may be established for a UP protocol stack at devices according to some embodiments of the present disclosure;

FIG. 2 illustrates a schematic diagram illustrating a process for communication according to embodiments of the present disclosure;

FIG. 3 illustrates a schematic diagram illustrating an example process of indicating a reference configuration according to embodiments of the present disclosure;

FIG. 4 illustrates a schematic diagram illustrating an example process of subsequent CPC according to embodiments of the present disclosure;

FIG. 5 illustrates a schematic diagram illustrating another example process of subsequent CPC according to embodiments of the present disclosure;

FIG. 6 illustrates an example method of communication implemented at a terminal device in accordance with some embodiments of the present disclosure;

FIG. 7 illustrates another example method of communication implemented at a terminal device in accordance with some embodiments of the present disclosure;

FIG. 8 illustrates still another example method of communication implemented at a terminal device in accordance with some embodiments of the present disclosure;

FIG. 9 illustrates an example method of communication implemented at a network device in accordance with some embodiments of the present disclosure;

FIG. 10 illustrates another example method of communication implemented at a network device in accordance with some embodiments of the present disclosure;

FIG. 11 illustrates still another example method of communication implemented at a network device in accordance with some embodiments of the present disclosure; and

FIG. 12 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “RRC configuration” may be interchangeably used with “radio resource configuration” or “configuration”. The term “delta configuration” may be interchangeably used with “delta radio resource configuration” or “delta RRC configuration”. The “RRC configuration” of one candidate cell is carried in one RRC Reconfiguration message when transmitted from a network device to the terminal device, or transmitted from one network device to another network device. “Applying one RRC configuration by the terminal device” can be referred to as “applying the RRC reconfiguration message”. The term “configuration for one candidate cell” may be referred to as “configuration associated with one candidate cell”.

As known, when a terminal device moves from a coverage area of one cell to that of another cell, a serving cell change needs to be performed at some point. Currently, a serving cell change is triggered by layer 3 (L3) measurements and is done by RRC signaling trigged reconfiguration with synchronization for change of a primary cell (PCell) of a MN and PSCell, as well as release for SCell if applicable. All these cases involve complete L2 and L1 resets, leading to a longer latency, larger overhead and longer interruption time than beam switch mobility. As a solution, a data transmission is performed with a change of a serving cell upon reception of a lower layer signaling such as L1 or L2 signaling, which is referred to as a L1/L2 based mobility. A goal of the L1/L2 based mobility is to enable a serving cell change via a lower layer signaling, in order to reduce the latency, overhead and interruption time.

For a conditional PSCell change (CPC)/conditional PSCell addition (CPA) in third generation partnership project (3GPP) Release 17, a CPC/CPA-configured terminal device has to release a CPC/CPA configuration when completing random access towards a target PSCell. Hence the terminal device has no chance to perform subsequent CPC/CPA without prior CPC/CPA reconfiguration and re-initialization from the network side. This will increase a delay for a cell change and increase signaling overhead, especially in the case of frequent SCG changes when operating in FR2. Therefore, multi-random access technology dual connectivity (MR-DC) with selective activation of cell groups aims at enabling subsequent CPC/CPA after SCG change, without reconfiguration and re-initialization on a CPC/CPA preparation from the network side. This results in a reduction of signaling overhead and an interrupting time for SCG change.

As mentioned above, a delta configuration is built on the basis of a source cell. For a subsequent CPC or subsequent L1/L2 based mobility, if a terminal device applies the delta configuration to the current serving cell and the current serving cell is different from the source cell, a wrong SCG configuration or even reconfiguration failure may occur.

Embodiments of the present disclosure provide solutions for a RRC configuration so as to solve the above or other potential issues. In one aspect, a terminal device receives a set of configurations for a set of candidate cells. The set of configurations are delta configurations. In this case, the terminal device determines a reference configuration, and applies a configuration for a candidate cell in the set of configurations based on the reference configuration. In this way, a delta configuration can be supported for a subsequent conditional PCell or PSCell change or subsequent L1/L2 based mobility.

In another aspect, a configuration for a candidate cell in the set of configurations is the same as a configuration for a serving cell of the terminal device or a configuration for a further candidate cell in the set of configurations, except for at least one of an identity, a timer, a dedicated random access channel configuration or a measurement configuration for a candidate cell. In this way, a delta configuration also can be supported for a subsequent conditional PCell or PSCell change or subsequent L1/L2 based mobility.

In still another aspect, configurations in the set of configurations are full configurations. In this way, the above issue for a delta configuration may be resolved.

Principles and implementations of the present disclosure will be described in detail below with reference to the figures.

### Example of Communication Network

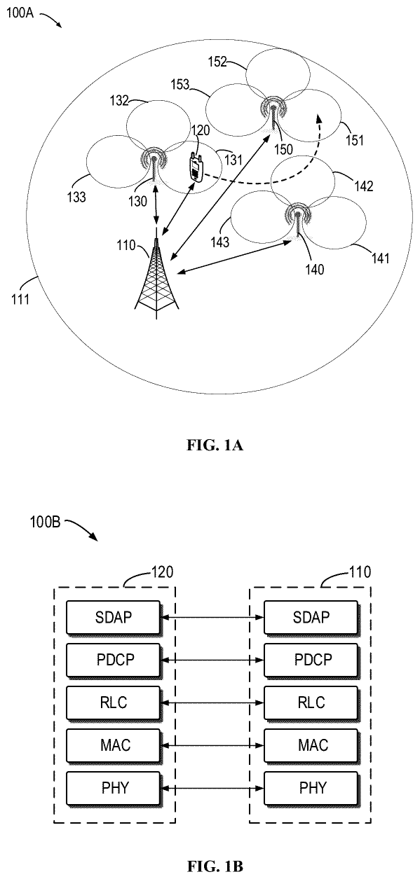

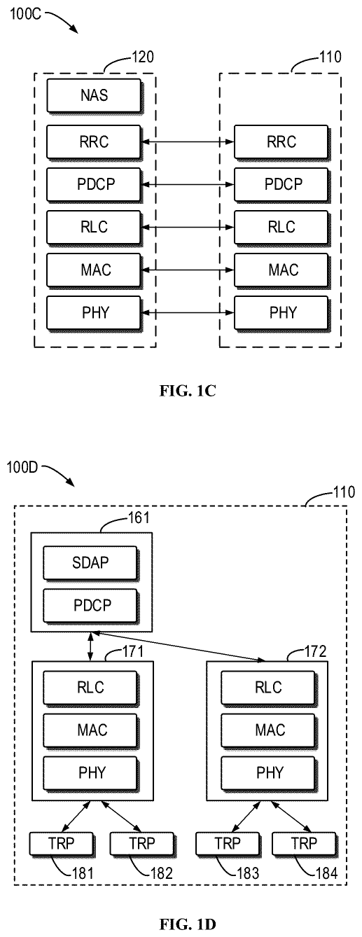

FIG. 1 illustrates a schematic diagram of an example communication environment 100 in which embodiments of the present disclosure can be implemented. As shown in FIG. 1, the communication environment 100 may comprise a network device 110 and a terminal device 120. The network device 110 provides a cell 111 and the terminal device 120 is located in the cell 111 and served by the network device 110.

The communication environment 100 may also comprise one or more other network devices such as network devices 130, 140 and 150. The network device 130 provides cells 131, 132 and 133. The network device 140 provides cells 141, 142 and 143, and the network device 150 provides cells 151, 152 and 153. It should be noted that the number of the cells are not limited to three, and more or less cells are also configured for the terminal device 110.

Assuming that the terminal device 120 may establish a dual connection (i.e., simultaneous connection) with two network devices. For example, the network device 110 may serve as a MN (for convenience, also referred to as MN 110 below), and the network device 130 may serve as a SN (for convenience, also referred to as SN 130 below). Although only the cell 111 is shown, the MN 110 may provide multiple cells, and these cells may form a MCG for the terminal device 120. Assuming that the cell 111 is a primary cell (i.e., PCell) in the MCG. Further, the cells 131, 132 and 133 provided by the network device 130 may form a SCG for the terminal device 120. Assuming that the cell 131 is a primary cell (i.e., PSCell) in the SCG.

The communication environment 100 may also comprise a core network 160. The core network 160 may comprise a user port function (UPF) 161 and an access management function (AMF) 162. It is to be understood that the core network 160 may also comprise any other suitable elements.

The SN 130 may communicate with the terminal device 120 via a channel such as a wireless communication channel. Similarly, the MN 110 may also communicate with the terminal device 120 via a channel such as a wireless communication channel. The SN 130 may communicate with the MN 110 via a control-plane interface such as Xn-C. The MN 110 may communicate with the core network 160 such as the AMF 162 via a control-plane interface such as NG-C. The SN 130 may also communicate with the MN 110 via a user plane interface such as Xn-U, and communicate with the core network 160 such as the UPF 161 via a user plane interface such as NG-U.

It is to be understood that the number of devices or cells in FIG. 1 is given for the purpose of illustration without suggesting any limitations to the present disclosure. The communication environment 100 may involve any suitable number of network devices and/or terminal devices and/or cells adapted for implementing implementations of the present disclosure.

The communications in the communication environment 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

Communication in a direction from the terminal device 120 towards the network device 110, 130, 140 or 150 is referred to as UL communication, while communication in a reverse direction from the network device 110, 130, 140 or 150 towards the terminal device 120 is referred to as DL communication. The terminal device 120 can move amongst the cells of the network devices 110, 130, 140 or 150 and possibly other network devices. In UL communication, the terminal device 120 may transmit UL data and control information to the network device 110, 130, 140 or 150 via a UL channel. In DL communication, the network device 110, 130, 140 or 150 may transmit DL data and control information to the terminal device 120 via a DL channel.

The communications in the communication network 100A can be performed in accordance with UP and CP protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for UP protocol stack at devices according to some embodiments of the present disclosure. For convenience, the following description is given by taking a communication between the terminal device 120 and the network device 110 as an example. It is to be understood that the following description is also suitable for the communication between the terminal device 120 and the network device 130, 140 or 150.

As shown in FIG. 1B, in the UP, each of the terminal device 120 and the network device 110 may comprise an entity for the L1 layer, i.e., an entity for a physical (PHY) layer (also referred to as a PHY entity), and one or more entities for upper layers (L2 and layer 3 (L3) layers, or upper layers) including an entity for a media access control (MAC) layer (also referred to as a MAC entity), an entity for a radio link control (RLC) layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for CP protocol stack at devices according to some embodiments of the present disclosure. As shown in FIG. 1C, in the CP, each of the terminal device 120 and the network device 110 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a radio resource control (RRC) layer (also referred to as a RRC entity). The RRC layer may be also referred to as an access stratum (AS) layer, and thus the RRC entity may be also referred to as an AS entity. As shown in FIG. 1C, the terminal device 120 may also comprise an entity for a non-access stratum (NAS) layer (also referred to as a NAS entity). An NAS layer at the network side is not located in a network device and is located in a core network (CN, not shown). In some cases, these entities are in a stack structure.

In the context of the present disclosure, L1 refers to the PHY layer, L2 refers to the MAC or RLC or PDCP or SDAP layer, and L3 refers to the RRC layer. In the context of the present disclosure, L1 or L2 may also be collectively referred to as a lower-layer, and L3 may also be referred to as a higher-layer. Accordingly, L1 or L2 signaling may be also referred to as a lower-layer signaling, and L3 signaling may be also referred to as a higher-layer signaling.

FIG. 1D illustrates a schematic diagram 100D of a CU/DU architecture that may be established for a UP protocol stack at devices according to some embodiments of the present disclosure. The CU/DU architecture may be established at a network device. For illustration, the following description is given by taking the network device 110 as an example.

As shown in FIG. 1D, in the UP, the network device 110 may comprise one or more CUs. Here, only one CU 161 is shown for convenience. Each CU 161 may communicate with multiple DUs. Here, two DUs 171 and 172 are shown for illustration. It is to be understood that more DUs may also be provided for implementation of embodiments of the present disclosure. As shown, CU 161 may be responsible for accomplishing the functionalities of the SDAP entity and the PDCP entity, and DU 171 or 172 may be responsible for accomplishing the functionalities of the RLC entity, the MAC entity and the PHY entity. DU 171 may communicate with transmission and reception points (TRPs) 181 and 182. DU 172 may communicate with TRPs 163 and 164. It is to be understood that this is merely an example, and more or less TRPs are also feasible. The terminal device 120 may communicate with any of these TRPs so as to communicate with the network device 110.

In some embodiments, the terminal device 120 may switch from one TRP to another TRP under control of the same CU and same DU. For example, the terminal device 120 may be handed over from TRP 181 to TRP 182. This is called as an intra-DU serving cell change. In some embodiments, the terminal device 120 may switch from one TRP to another TRP under control of the same CU and different DUs. For example, the terminal device 120 may be handed over from TRP 182 to TRP 183. In this case, a cell change from DU 181 to DU 182 will occur. This is called as an inter-DU serving cell change. The cell change among DUs 181, 182, 183 and 184 is called as an intra-CU handover.

In some scenarios, the terminal device 120 may receive, from a network device as a MN or SN, a configuration of SSBs of cells with different PCIs for serving cell change and a RRC configuration for candidate cells, and store the RRC configuration of the candidate cells for L1/L2 based mobility. The terminal device 120 may perform a beam measurement for the candidate cells and report the beam measurement to the network device. The terminal device 120 may receive, from the network device, a L1 or L2signaling indicating a change of a serving cell to a selected candidate cell (i.e., new serving cell), and TCI state for the selected candidate cell is activated along with the serving cell change. This procedure may be called as a L1/L2 based mobility. The terminal device 120 may not need to discard the stored RRC configuration. If the terminal device 120 further receives, from the new serving cell, a L1 or L2 signaling indicating a change of a serving cell, the terminal device 120 may perform a data transmission with the change of the serving cell. This procedure may be called as a subsequent L1/L2 based mobility. The stored RRC configuration for the candidate cells may be used for the subsequent L1/L2based mobility procedures.

Return to FIG. 1A, in some embodiments, the network device 110 may configure a conditional reconfiguration for the terminal device 120. Assuming that the cells 131-133, 141-143 and 151-153 are configured to the terminal device 110 as candidate cells. In some scenarios, the terminal device 120 may initially communicate with only the network device 110. As the terminal device 120 moves, when a condition for a candidate cell (for example, the cell 131) is fulfilled, the terminal device 120 may be caused to establish the dual connection with the network device 110 and the network device 130. This process of SN addition may be called as a CPA.

In some scenarios, the terminal device 120 may establish a dual connection with the network devices 110 and 130. The network device 110 serves as a MN and the network device 130 serves as a SN. As the terminal device 120 moves, when a condition for another candidate cell (for example, the cell 142) is fulfilled, a SN serving the terminal device 120 may be changed from the network device 130 (also referred to as a source SN or current SN 130) to the network device 140 (also referred to as a target SN 140). This process of PScell change may be called as a CPC. In some scenarios, after the terminal device is configured with conditional reconfiguration and with subsequent CPC being enabled, and before at least one execution condition is fulfilled for any candidate PScell, the terminal device 120 may receive a RRC Reconfiguration message containing reconfiguration WithSync for SCG from the network device 110, and the terminal device 120 may perform a PScell change or addition accordingly. This procedure is called as legacy PScell change or addition.

After the above CPA, CPC or legacy PSCell change/addition procedure, as the terminal device 120 further moves, when a condition for still another candidate cell (for example, the cell 152) is fulfilled, a SN serving the terminal device 120 may be changed from the network device 140 to the network device 150 (also referred to as a target SN 150). This process of SN change may be called as a subsequent CPC.

In 3GPP Release 18, a mechanism and procedure of NR-DC with selective activation of the cell groups (at least for SCG) will be specified by allowing subsequent cell group change after changing CG without reconfiguration and re-initiation of CPC/CPA. In this case, the terminal device 120 may not need to discard the CPC/CPA configuration after completion of PSCell change/addition procedure. The stored CPC/CPA configuration may be used for the subsequent CPC.

However, the terminal device 120 may be provided with a delta configuration with respect to a configuration of a source cell. A serving cell may keep changing during the subsequent CPC and may be different from the source cell. Thus, how to apply the delta configuration for the current serving cell becomes an issue.

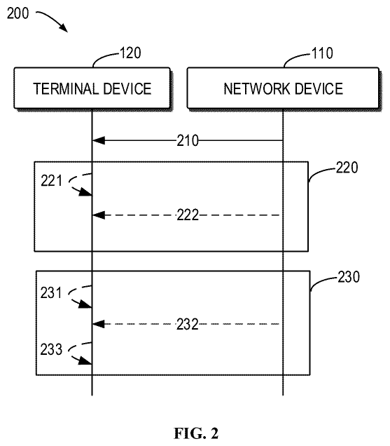

Embodiments of the present disclosure provide a solution for solving the delta configuration issue for the above subsequent CPC or L1/L2 based mobility scenario or any other suitable scenarios. Its details will be described with reference to FIGS. 2 to 5.

It is to be understood that the present solution may be applied in a SCG change, and also may be applied in a MCG change. That is, the present solution may be applied for a subsequent CPC or a subsequent conditional handover. The subsequent CPC or subsequent conditional handover may also be referred to as a selective activation of cell groups, a selective activation of SCGs, a subsequent SCG change, a subsequent cell group change or a subsequent conditional cell change. For convenience, embodiments of the present disclosure will be described by taking a subsequent CPC as an example.

### Example Implementation of Applying Delta Configuration

FIG. 2 illustrates a schematic diagram illustrating a process 200 for communication according to embodiments of the present disclosure. For the purpose of discussion, the process 200 will be described with reference to FIG. 1A. The process 200 may involve the terminal device 120 and the network device 110 as illustrated in FIG. 1A. The network device 110 may be a MN or SN serving the terminal device 120.

As shown in FIG. 2, the network device 110 transmits 210, to the terminal device 120, a set of configurations for a set of candidate cells. Configurations in the set of configurations are delta configurations.

The terminal device 120 determines 220 a reference configuration. In some embodiments, the terminal device 120 may determine, as the reference configuration, the configuration used for a cell group serving the terminal device 120. For example, upon reception of a RRC reconfiguration message comprising a configuration of an enabling of a subsequent conditional cell change or L1/L2 based mobility, the terminal device 120 may determine the current RRC configuration as the reference configuration.

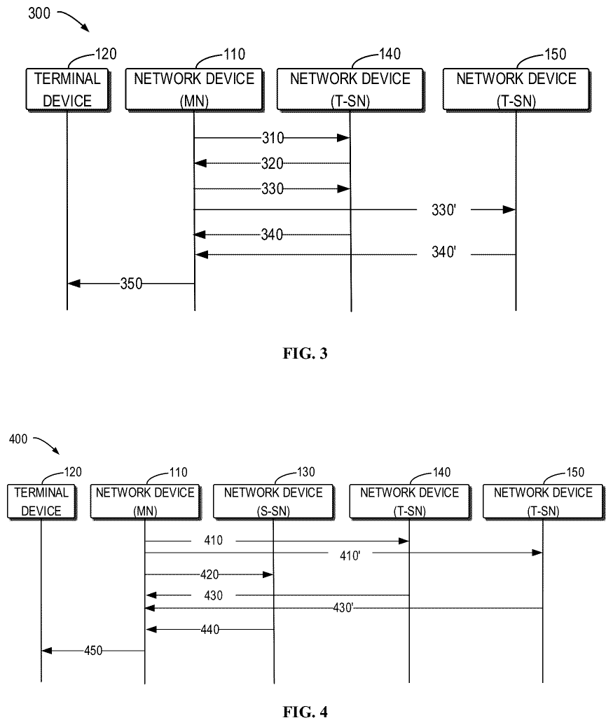

In some embodiments, the network device 110 may transmit 222, to the terminal device 120, an indication indicating a configuration for one of the set of candidate cells as the reference configuration. In this case, the terminal device 120 may determine the configuration for the one of the set of candidate cells as the reference configuration based on the indication. For example, the network device 110 may obtain a RRC configuration (a full configuration) corresponding to a candidate cell which is used as basis of a delta configuration, and then provide the RRC configuration to at least one network device of at least one other candidate cell. Then each of the at least one network device may generate a delta configuration for a corresponding candidate cell using the provided RRC configuration as a basis. The network device 120 may transmit a RRC reconfiguration comprising conditional cell change or addition configuration or L1/L2 based mobility configuration to the terminal device 110. The conditional cell change or addition configuration or L1/L2 based mobility configuration may consist of a set of RRC configurations for a set of candidate cells. The network device 120 may indicate, in the RRC reconfiguration, which entry in the set of RRC configurations is the basis of a delta configuration. For illustration, an example for a subsequent CPC will be given below with reference to FIG. 3.

FIG. 3 illustrates a schematic diagram illustrating an example process 300 of indicating a reference configuration according to embodiments of the present disclosure. For the purpose of discussion, the process 300 will be described with reference to FIG. 1A. The process 300 may involve the terminal device 120 and the network devices 110, 140 and 150 as illustrated in FIG. 1A. In this example, the network device 110 serves as a MN serving the terminal device 120, the network device 140 serves as a potential target SN (denoted as T-SN), and the network device 150 serves as another potential target SN.

As shown in FIG. 3, the network device 110 may transmit 310, to the network device 140, a SN addition request message comprising information of subsequent CPC and a candidate PScell #1. The network device 140 may transmit 320, to the network device 110, a SN addition request acknowledge message comprising a SCG configuration of the candidate PScell #1. In a subsequent CPC stage, the network device 110 may transmit 330, to the network device 140, a SN addition request message comprising information of the subsequent CPC, list of other candidate PSCells and a SCG configuration of the candidate PScell #1. The network device 110 may also transmit 330′, to the network device 150, a SN addition request message comprising information of the subsequent CPC, list of other candidate PSCells and a SCG configuration of the candidate PScell #1. The network device 140 may transmit 340, to the network device 110, a SN addition request acknowledge message comprising configurations of other candidate PScells, the configurations are delta configuration based on the SCG configuration of candidate PSCell #1. The network device 150 may also transmit 340′, to the network device 110, a SN addition request acknowledge message comprising configurations of other candidate PScells, and these configurations are delta configurations based on the SCG configuration of candidate PSCell #1. Then the network device 110 may transmit 350, to the terminal device 120, a RRC reconfiguration message comprising conditional reconfiguration, the conditional reconfiguration comprising configuration for the candidate PSCells and an indication indicating which entry in the CPC/CPA configurations is the basis of the delta configurations. It is to be understood that the process of FIG. 3 is merely an example, and does not limit the present disclosure.

In some embodiments, the terminal device 120 may store 221 the reference configuration. For example, the reference configuration may be stored in one UE variable. For example, upon reception of a RRC reconfiguration message comprising a configuration of an enabling of a subsequent conditional cell change or L1/L2 based mobility, the terminal device 120 may store the RRC configuration corresponding to each candidate cell. The terminal device 120 may also store the reference configuration in one UE variable. In some embodiments, the terminal device 120 may replace a stored reference RRC configuration with the new received reference configuration. Then the terminal device 120 may transmit a RRC reconfiguration complete message to the network device 110.

In some embodiments, the terminal device 120 may discard the stored reference RRC configuration if the cell group is released. In some embodiments, the terminal device 120 may discard the stored reference RRC configuration if a handover is performed, e.g., if a reconfigurationWithSync for MCG is performed. In some embodiments, the terminal device 120 may discard the stored reference RRC configuration upon if the configuration for the candidate cell is released, e.g., if a conditional reconfiguration or L1/L2 based mobility configuration is released. In some embodiments, the terminal device 120 may discard the stored reference RRC configuration if a subsequent conditional cell change is disabled. In this way, a storage resource may be well managed.

Upon determination of the reference configuration, the terminal device 120 applies 230, based on the reference configuration, a configuration for a candidate cell in the set of configurations. In some embodiments for a subsequent conditional PSCell or PCell change, if at least one execution condition for the candidate cell (also referred to as a selected candidate cell) is fulfilled, the terminal device 120 may apply 231 the configuration for the candidate cell. In some embodiments for L1/L2 based mobility, the terminal device 120 may receive 232, from the network device 110, a lower layer signaling (for example, L1 or L2 signaling which can be medium access control (MAC) control element (CE) or downlink control information (DCI)) which indicates the candidate cell. In this case, the terminal device 120 may apply 233 the configuration for the candidate cell in response to the lower layer signaling.

In some embodiments where the current RRC configuration is stored as the reference configuration, the terminal device 120 may revert back (i.e., fallback) to the stored RRC configuration and then apply the configuration for the candidate cell. Alternatively, the terminal device 120 may generate an actual configuration (for convenience, also referred to as a first configuration herein) based on the reference configuration and the configuration for the candidate cell, and apply the first configuration for the candidate cell. In other words, the terminal device applies the first configuration for the candidate cell when an execution condition is fulfilled or a lower layer signaling is received.

In some embodiments, the terminal device 120 may generate a set of configurations (for convenience, also referred to as a set of second configurations) for the set of candidate cells based on the reference configuration and the set of configurations for the set of candidate cells, and store the set of second configurations. For example, upon reception of a RRC reconfiguration message comprising a set of configurations for a set of candidate cells, and the configurations of the candidate cells are delta configurations, the terminal device 120 may use or combine the reference RRC configuration and configuration corresponding to each candidate cell to generate a new or actual RRC configuration (i.e., the second configuration) corresponding to the candidate cell. Then the terminal device 120 may store the second configurations for the candidate cells in a variable of the terminal device 120, or the terminal device 120 may replace or update the stored second RRC configurations with the newly generated second RRC configuration of the candidate cells. In these embodiments, the terminal device 120 may directly apply the currently stored second RRC configuration for the candidate cell upon an execution condition is fulfilled or a lower signaling is received.

So far, a solution for applying a delta configuration is described. In this way, a delta configuration may be supported for a subsequent conditional PCell or PSCell change or subsequent L1/L2 based mobility or any other suitable scenarios.

### Example Implementation of Same Delta Configuration

Embodiments of the present disclosure also provide a solution of using substantially the same delta configuration for the set of candidate cells. For convenience, this solution will be described with reference to FIG. 1A.

In this solution, the terminal device 120 receives, from the network device 110, a set of configurations for a set of candidate cells, and if a cell change or addition to a candidate cell in the set of candidate cells is to be performed, the terminal device 120 applies a configuration for the candidate cell in the set of configurations. The configuration for the candidate cell is the same as a configuration for a cell group serving the terminal device or a configuration for a further candidate cell in the set of configurations, except for at least one of an identity, a timer, a dedicated random access channel (RACH) configuration or a measurement configuration for the terminal device 120. In other words, the configurations of the all candidate cells from are the same as the current configuration or configuration one candidate cell, except for at least one of an identity, a timer, a dedicated RACH configuration or a measurement configuration. For example, the identity for the terminal device may be a cell-radio network temporary identifier (C-RNTI) of the terminal device 120 for a candidate cell. Of course, any other suitable forms are also feasible. The timer may be a T304 timer or any other similar timers.

For illustration, an example for a subsequent CPC will be given below with reference to FIG. 4. FIG. 4 illustrates a schematic diagram illustrating an example process 400 of subsequent CPC according to embodiments of the present disclosure. For the purpose of discussion, the process 400 will be described with reference to FIG. 1A. The process 400 may involve the terminal device 120 and the network devices 110, 130, 140 and 150 as illustrated in FIG. 1A. In this example, the network device 110 serves as a MN serving the terminal device 120, the network device 130 serves as a source SN (denoted as S-SN), the network devices 140 and 150 serve as potential target SNs (denoted as T-SN).

As shown in FIG. 4, in a subsequent CPC stage, the network device 110 may transmit 410, to the network device 140, a SN addition request message comprising information of enabling subsequent CPC and the current SCG configuration of S-SN or a SCG configuration of one candidate PSCell. The network device 110 may also transmit 410′, to the network device 150, a SN addition request message comprising information of subsequent CPC and the current SCG configuration of S-SN or a SCG configuration of one candidate PSCell. The network device 110 may transmit 420, to the network device 130, an Xn message comprising information of the enabling of subsequent CPC. The network device 140 may transmit 430, to the network device 110, a SN addition request acknowledge message comprising only at least one of an identity, a timer, a dedicated random access channel configuration or a measurement configuration as a SCG configuration for each candidate PSCell. The network device 150 may also transmit 430′, to the network device 110, a SN addition request acknowledge message comprising only at least one of an identity, a timer, a dedicated RACH configuration or a measurement configuration as a SCG configuration for each candidate PSCell. The network device 130 may transmit 440 an Xn message for acknowledgement of the enabling of subsequent CPC comprising only at least one of an identity, a timer, a dedicated RACH configuration or a measurement configuration as a SCG configuration for each candidate PSCell. The network device 110 may transmit 450, to the terminal device 120, a RRC reconfiguration message comprising a set of configurations for a set of candidate cells, and a configuration for each candidate cell comprises only at least one of an identity, a timer, a dedicated RACH configuration or a measurement configuration as a SCG configuration for each candidate PSCell. It is to be understood that the process of FIG. 4 is merely an example, and does not limit the present disclosure.

In some embodiments, if the configuration for the candidate cell is the same as the configuration for the further candidate cell in the set of candidate cells, the terminal device 120 may receive, from the network device 110, an indication indicating the further candidate cell, and apply the configuration for the candidate cell based on the indication.

In some embodiments for a subsequent conditional PSCell or PCell change, if at least one execution condition for the candidate cell is fulfilled, the terminal device 120 may apply the configuration for the candidate cell. In some embodiments for L1/L2 based mobility, the terminal device 120 may receive, from the network device 110, a lower layer signaling (for example, L1 or L2 signaling) which indicates the candidate cell. In this case, the terminal device 120 may apply the configuration for the candidate cell in response to the lower layer signaling.

In this way, a delta configuration also can be supported for a subsequent conditional PCell or PSCell change or subsequent L1/L2 based mobility.

### Example Implementation of Full Configuration

Embodiments of the present disclosure also provide a solution of using a full configuration for each candidate cell in the set of candidate cells. For convenience, this solution will be described with reference to FIG. 1A.

In this solution, the terminal device 120 receives, from the network device 110, a set of configurations for a set of candidate cells, and each configuration in the set of configurations is a full configuration. In this way, if a cell change or addition to a candidate cell in the set of candidate cells is to be performed, the terminal device 120 directly applies a configuration for the candidate cell in the set of configurations.

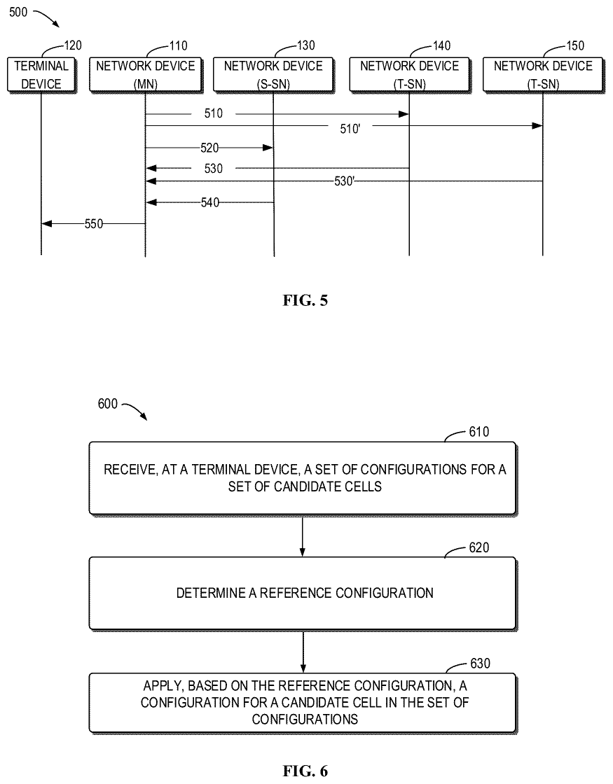

For illustration, an example for a subsequent CPC will be given below with reference to FIG. 5. FIG. 5 illustrates a schematic diagram illustrating another example process 500 of subsequent CPC according to embodiments of the present disclosure. For the purpose of discussion, the process 500 will be described with reference to FIG. 1A. The process 500 may involve the terminal device 120 and the network devices 110, 130, 140 and 150 as illustrated in FIG. 1A. In this example, the network device 110 serves as a MN serving the terminal device 120, the network device 130 serves as a source SN (denoted as S-SN), the network devices 140 and 150 serve as potential target SNs (denoted as T-SN).

As shown in FIG. 5, in a subsequent CPC stage, the network device 110 may transmit 510, to the network device 140, a SN addition request message comprising information of enabling subsequent CPC, wherein the SN addition request message does not include current SCG configuration because network device 110 uses a full configuration. The network device 110 may also transmit 510′, to the network device 150, a SN addition request message comprising information of subsequent CPC. The network device 110 may transmit 520, to the network device 130, an Xn message comprising information of the enabling of subsequent CPC, wherein the SN addition request message does not include current SCG configuration because network device 110 uses a full configuration. The network device 140 may transmit 530, to the network device 110, a SN addition request acknowledge message comprising a SCG configuration using a full configuration for each candidate PSCell. The network device 150 may also transmit 530′, to the network device 110, a SN addition request acknowledge message comprising a SCG configuration using a full configuration for each candidate PSCell. The network device 130 may transmit 540 an Xn message for acknowledgement of the enabling of subsequent CPC comprising a SCG configuration using a full configuration for each candidate PSCell. The network device 110 may transmit 550, to the terminal device 120, a RRC reconfiguration message comprising conditional reconfiguration for CPC/CPA, and the conditional reconfiguration comprises the configuration using a full configuration for each candidate PSCell. It is to be understood that the process of FIG. 5 is merely an example, and does not limit the present disclosure.

In some embodiments for a subsequent conditional PSCell or PCell change, if at least one execution condition for the candidate cell is fulfilled, the terminal device 120 may apply the configuration for the candidate cell. In some embodiments for L1/L2 based mobility, the terminal device 120 may receive, from the network device 110, a lower layer signaling (for example, L1 or L2 signaling) which indicates the candidate cell. In this case, the terminal device 120 may apply the configuration for the candidate cell in response to the lower layer signaling.

In this way, a full configuration also can be supported for a subsequent conditional PCell or PSCell change or subsequent L1/L2 based mobility.

### Example Implementation of Dedicate RACH Configuration

Currently, a dedicated RACH configuration is to be configured for the reconfiguration WithSync procedure (e.g. for handover or PSCell change). If subsequent conditional cell change is enabled or if subsequent L1/L2 based cell change is configured for a terminal device, the dedicated RACH configuration needs to be reserved for a very long time. Thus, huge cost and resource waste will be caused.

In view of this, embodiments of the present disclosure also provide solutions for resource management. For convenience, these solutions will be described with reference to FIG. 1A.

In some embodiments, a configuration for a candidate cell may comprise a dedicated RACH configuration for the candidate cell. In these embodiments, the terminal device 120 may perform the cell change or addition to the candidate cell based on the dedicated RACH configuration once. If a further cell change to the candidate cell is to be performed, the terminal device 120 may perform the further cell change without using the dedicated RACH configuration. For example, the terminal device 120 may perform the further cell change based on a contention based random access procedure. In this way, the dedicated RACH resource may be reserved for a short time.

In some embodiments, a configuration for a candidate cell may comprise a dedicated RACH configuration for a cell change or addition and a timer configured for the candidate cell. In these embodiments, if the configuration is received, the terminal device 120 may start the timer. If the timer expires, the terminal device 120 may release the dedicated RACH configuration. In this way, a timer is used to control the use of the dedicated RACH configuration, and thus the dedicated RACH resource also may be reserved for a short time.

In some embodiments, a configuration for a candidate cell may not comprise a dedicated RACH configuration for the candidate cell. In other words, the dedicated RACH configuration is not configured if subsequent CPC or lower layer signaling based mobility is configured. In these embodiments, the terminal device 120 may perform a cell change or cell addition to a candidate cell only based on a contention based random access procedure. In this way, the above issue related to a dedicated RACH configuration may also be resolved.

### Example Implementation of Methods

Accordingly, embodiments of the present disclosure provide methods of communication implemented at a terminal device and a network device. These methods will be described below with reference to FIGS. 6 to 11.

FIG. 6 illustrates an example method 600 of communication implemented at a terminal device in accordance with some embodiments of the present disclosure. For example, the method 600 may be performed at the terminal device 120 as shown in FIG. 1A. For the purpose of discussion, in the following, the method 600 will be described with reference to FIG. 1A. It is to be understood that the method 600 may include additional blocks not shown and/or may omit some blocks as shown, and the scope of the present disclosure is not limited in this regard.

At block 610, the terminal device 120 receives, from a first network device (for example, the network device 110) serving the terminal device 120, a set of configurations for a set of candidate cells. In some embodiments for subsequent conditional cell change, the first network device may be a MN. In some embodiments for L1/L2 based mobility, the first network device may be a MN or a SN.

At block 620, the terminal device 120 determines a reference configuration. In some embodiments, the terminal device 120 may determine, as the reference configuration, a configuration of a cell group serving the terminal device 120. In some embodiments, the terminal device 120 may receive, from the first network device, an indication indicating a configuration for one of the set of candidate cells as the reference configuration, and determine the reference configuration based on the indication.

In some embodiments, the terminal device 120 may store the reference configuration in a variable of the terminal device. In some embodiments, the terminal device 120 may discard the stored reference configuration in response to at least one of the following: the cell group being released; a handover being performed; the configuration for the candidate cell being released; or a subsequent conditional cell change being disabled.

At block 630, the terminal device 120 applies, based on the reference configuration, a configuration for a candidate cell in the set of configurations. In some embodiments, if at least one execution condition for the candidate cell is fulfilled, the terminal device 120 may apply the configuration for the candidate cell. In some embodiments, if a lower layer signaling is received, the terminal device 120 may apply the configuration for the candidate cell.

In some embodiments, the terminal device 120 may revert back to the reference configuration, and apply the configuration for the candidate cell. In some embodiments, the terminal device 120 may generate a first configuration based on the reference configuration and the configuration for the candidate cell, and apply the first configuration for the candidate cell. In some embodiments, the terminal device 120 may generate a set of second configurations for the set of candidate cells based on the reference configuration and the set of configurations for the set of candidate cells, and store the set of second configurations. The terminal device 120 may directly apply a stored second configuration for the candidate cell.

In some embodiments where the configuration comprises a dedicated random access configuration for the candidate cell, the terminal device 120 may perform a cell change or addition to the candidate cell based on the dedicated random access configuration.

If a further cell change to the candidate cell is to be performed, the terminal device 120 may perform the further cell change without using the dedicated random access configuration.

In some embodiments where the configuration comprises a dedicated random access configuration for a cell change or addition and a timer configured for the candidate cell, if the configuration is received, the terminal device 120 may start the timer. If the timer expires, the terminal device 120 may release the dedicated random access configuration.

In some embodiments, the terminal device 120 may perform a cell change or cell addition to the candidate cell only based on a contention based random access procedure.

In this way, a delta configuration may be supported for subsequent conditional cell change or L1/L2 based mobility or any other suitable scenarios.

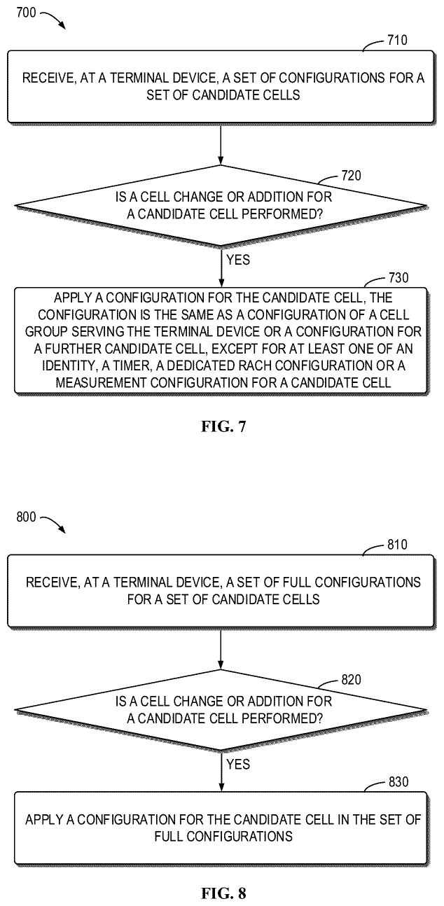

FIG. 7 illustrates another example method 700 of communication implemented at a terminal device in accordance with some embodiments of the present disclosure. For example, the method 700 may be performed at the terminal device 120 as shown in FIG. 1A. For the purpose of discussion, in the following, the method 700 will be described with reference to FIG. 1A. It is to be understood that the method 700 may include additional blocks not shown and/or may omit some blocks as shown, and the scope of the present disclosure is not limited in this regard.

At block 710, the terminal device 120 receives, from a first network device (for example, the network device 110) serving the terminal device 120, a set of configurations for a set of candidate cells. In some embodiments for subsequent conditional cell change, the first network device may be a MN. In some embodiments for L1/L2 based mobility, the first network device may be a MN or a SN.

At block 720, the terminal device 120 determines whether a cell change or addition to a candidate cell in the set of candidate cells is to be performed. If the cell change or addition to the candidate cell is to be performed, the process 700 proceeds to block 730.

At block 730, the terminal device 120 applies a configuration for a candidate cell in the set of configurations. The configuration for the candidate cell is the same as a configuration of a cell group serving the terminal device 120 or a configuration for a further candidate cell in the set of candidate cells, except for at least one of the following: an identity for a candidate cell in the set of candidate cells; a timer for a candidate cell in the set of candidate cells; a dedicated random access channel configuration for a candidate cell in the set of candidate cells; or a measurement configuration of a candidate cell in the set of candidate cells.

In some embodiments where the configuration for the candidate cell is the same as the configuration for the further candidate cell in the set of candidate cells, the terminal device 120 may receive, from the first network device, an indication indicating the further candidate cell, and apply the configuration for the candidate cell based on the indication.

In some embodiments, if at least one execution condition for the candidate cell is fulfilled, the terminal device 120 may apply the configuration for the candidate cell. In some embodiments, if a lower layer signaling is received, the terminal device 120 may apply the configuration for the candidate cell.

In some embodiments where the configuration comprises a dedicated random access configuration for the candidate cell, the terminal device 120 may perform a cell change or addition to the candidate cell based on the dedicated random access configuration. If a further cell change to the candidate cell is to be performed, the terminal device 120 may perform the further cell change without using the dedicated random access configuration.

In some embodiments where the configuration comprises a dedicated random access configuration for a cell change or addition and a timer configured for the candidate cell, if the configuration is received, the terminal device 120 may start the timer. If the timer expires, the terminal device 120 may release the dedicated random access configuration.

In some embodiments, the terminal device 120 may perform a cell change or cell addition to the candidate cell only based on a contention based random access procedure.

In this way, a delta configuration may be supported for subsequent conditional cell change or L1/L2 based mobility or any other suitable scenarios.

FIG. 8 illustrates still another example method 800 of communication implemented at a terminal device in accordance with some embodiments of the present disclosure. For example, the method 800 may be performed at the terminal device 120 as shown in FIG. 1A. For the purpose of discussion, in the following, the method 800 will be described with reference to FIG. 1A. It is to be understood that the method 800 may include additional blocks not shown and/or may omit some blocks as shown, and the scope of the present disclosure is not limited in this regard.

At block 810, the terminal device 120 receives, from a first network device (for example, the network device 110) serving the terminal device 120, a set of full configurations for a set of candidate cells. In some embodiments for subsequent conditional cell change, the first network device may be a MN. In some embodiments for L1/L2 based mobility, the first network device may be a MN or a SN.

At block 820, the terminal device 120 determines whether a cell change or addition to a candidate cell in the set of candidate cells is to be performed. If the cell change or addition to the candidate cell is to be performed, the process 800 proceeds to block 830.

At block 830, the terminal device 120 applies a configuration for a candidate cell in the set of full configurations.

In some embodiments, if at least one execution condition for the candidate cell is fulfilled, the terminal device 120 may apply the configuration for the candidate cell. In some embodiments, if a lower layer signaling is received, the terminal device 120 may apply the configuration for the candidate cell.

In some embodiments where the configuration comprises a dedicated random access configuration for the candidate cell, the terminal device 120 may perform a cell change or addition to the candidate cell based on the dedicated random access configuration. If a further cell change to the candidate cell is to be performed, the terminal device 120 may perform the further cell change without using the dedicated random access configuration.

In some embodiments where the configuration comprises a dedicated random access configuration for a cell change or addition and a timer configured for the candidate cell, if the configuration is received, the terminal device 120 may start the timer. If the timer expires, the terminal device 120 may release the dedicated random access configuration.

In some embodiments, the terminal device 120 may perform a cell change or cell addition to the candidate cell only based on a contention based random access procedure.

In this way, a delta configuration may be supported for subsequent conditional cell change or L1/L2 based mobility or any other suitable scenarios.

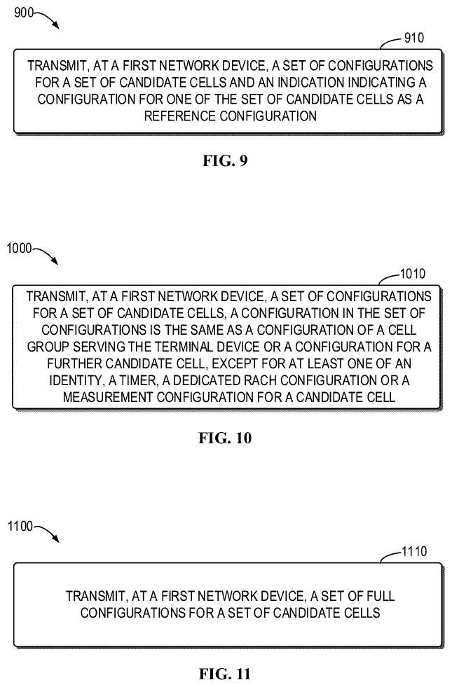

FIG. 9 illustrates an example method 900 of communication implemented at a network device in accordance with some embodiments of the present disclosure. The method 900 may be performed at a first network device. In some embodiments for subsequent conditional cell change, the first network device may be a MN. In some embodiments for L1/L2 based mobility, the first network device may be a MN or a SN. For the purpose of discussion, the method 900 will be described with reference to in FIG. 1A. It is to be understood that the method 900 may include additional blocks not shown and/or may omit some blocks as shown, and the scope of the present disclosure is not limited in this regard.

As shown in FIG. 9, at block 910, the first network device (for example, the network device 110) transmits, to the terminal device 120, a set of configurations for a set of candidate cells, and an indication indicating a configuration for one of a set of candidate cells as a reference configuration.

In some embodiments, the network device 110 may transmit the configuration for the one of the set of candidate cells to a set of second network devices (for example, the network devices 140 and 150) providing the set of candidate cells, and receive, from the set of second network devices, the set of configurations generated based on the configuration for the one candidate cell as the reference configuration.

In some embodiments, the configuration for the candidate cell comprises a dedicated random access configuration for a candidate cell in the set of candidate cells. In some embodiments, the configuration for the candidate cell comprises a dedicated random access configuration for the cell change or addition and a timer configured for a candidate cell in the set of candidate cells. In some embodiments, the configuration for the candidate cell does not comprise a dedicated random access configuration for the set of candidate cells.

In this way, a delta configuration may be supported for subsequent conditional cell change or L1/L2 based mobility or any other suitable scenarios.

FIG. 10 illustrates another example method 1000 of communication implemented at a network device in accordance with some embodiments of the present disclosure. The method 1000 may be performed at a first network device. In some embodiments for subsequent conditional cell change, the first network device may be a MN. In some embodiments for L1/L2 based mobility, the first network device may be a MN or a SN. For the purpose of discussion, the method 1000 will be described with reference to in FIG. 1A. It is to be understood that the method 1000 may include additional blocks not shown and/or may omit some blocks as shown, and the scope of the present disclosure is not limited in this regard.

As shown in FIG. 10, at block 1010, the first network device (for example, the network device 110) transmits, to the terminal device 120, a set of configurations for a set of candidate cells. A configuration for a candidate cell in the set of candidate cells is the same as a configuration of a cell group serving the terminal device 120 or a configuration for a further candidate cell in the set of candidate cells, except for at least one of the following: an identity for a candidate cell in the set of candidate cells; a timer for a candidate cell in the set of candidate cells; a dedicated random access channel configuration for a candidate cell in the set of candidate cells; or a measurement configuration of a candidate cell in the set of candidate cells.

In some embodiments, the network device 110 may receive the set of configurations from a set of second network devices (for example, the network devices 140 and 150) providing the set of candidate cells.

In some embodiments where the configuration for the candidate cell is the same as the configuration for the further candidate cell in the set of candidate cells, the network device 110 may transmit, to the terminal device 120, an indication indicating the further candidate cell.

In some embodiments, the configuration for the candidate cell comprises a dedicated random access configuration for a candidate cell in the set of candidate cells. In some embodiments, the configuration for the candidate cell comprises a dedicated random access configuration for the cell change or addition and a timer configured for a candidate cell in the set of candidate cells. In some embodiments, the configuration for the candidate cell does not comprise a dedicated random access configuration for the set of candidate cells.

In this way, a delta configuration may be supported for subsequent conditional cell change or L1/L2 based mobility or any other suitable scenarios.

FIG. 11 illustrates still another example method 1100 of communication implemented at a network device in accordance with some embodiments of the present disclosure. The method 1100 may be performed at a first network device. In some embodiments for subsequent conditional cell change, the first network device may be a MN. In some embodiments for L1/L2 based mobility, the first network device may be a MN or a SN. For the purpose of discussion, the method 1100 will be described with reference to in FIG. 1A. It is to be understood that the method 1100 may include additional blocks not shown and/or may omit some blocks as shown, and the scope of the present disclosure is not limited in this regard.

As shown in FIG. 11, at block 1110, the first network device (for example, the network device 110) transmits, to the terminal device 120, a set of configurations for a set of candidate cells. A configuration in the set of configurations is a full configuration for a candidate cell. That is, each configuration in the set of configurations is a full configuration.

In some embodiments, the network device 110 may receive the set of full configurations from a set of second network devices (for example, the network devices 140 and 150) providing the set of candidate cells.

In some embodiments, the configuration for the candidate cell comprises a dedicated random access configuration for a candidate cell in the set of candidate cells. In some embodiments, the configuration for the candidate cell comprises a dedicated random access configuration for the cell change or addition and a timer configured for a candidate cell in the set of candidate cells. In some embodiments, the configuration for the candidate cell does not comprise a dedicated random access configuration for the set of candidate cells.

In this way, a delta configuration may also be supported for subsequent conditional cell change or L1/L2 based mobility or any other suitable scenarios.

It is to be understood that the operations of methods 600 to 1100 are similar as that described in connection with FIGS. 2 to 5, and thus other details are not repeated here for concise.

### Example Implementation of Devices and Apparatuses

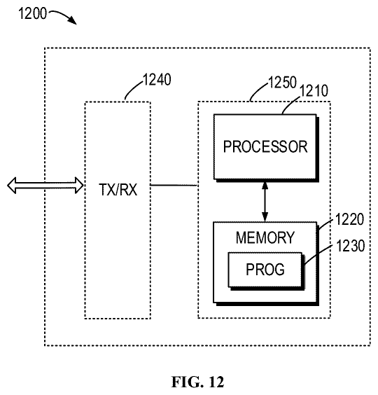

FIG. 12 is a simplified block diagram of a device 1200 that is suitable for implementing embodiments of the present disclosure. The device 1200 can be considered as a further example implementation of the terminal device 120 or the network devices 110, 130, 140 or 150 as shown in FIG. 1A. Accordingly, the device 1200 can be implemented at or as at least a part of the terminal device 120 or the network devices 110, 130, 140 or 150.

As shown, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1210 stores at least a part of a program 1230. The TX/RX 1240 is for bidirectional communications. The TX/RX 1240 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1230 is assumed to include program instructions that, when executed by the associated processor 1210, enable the device 1200 to operate in accordance with the embodiments of the present disclosure, as discussed herein with reference to FIGS. 1A to 11. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1220 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

In some embodiments, a terminal device comprises circuitry configured to: receive, from a first network device, a set of configurations for a set of candidate cells; determine a reference configuration; and apply, based on the reference configuration, a configuration for a candidate cell in the set of configurations.

In some embodiments, the circuitry may be configured to determine, as the reference configuration, a configuration of a cell group serving the terminal device.

In some embodiments, the circuitry may be configured to determine the reference configuration by receiving, from the first network device, an indication indicating a configuration for one of the set of candidate cells as the reference configuration; and determining the reference configuration based on the indication.

In some embodiments, the circuitry may be configured to store the reference configuration in a variable of the terminal device.

In some embodiments, the circuitry may be further configured to discard the stored reference configuration in response to at least one of the following: the cell group being released; a handover being performed; the configuration for the candidate cell being released; or a subsequent conditional cell change being disabled.

In some embodiments, the circuitry may be configured to apply the configuration by: reverting back to the reference configuration; and applying the configuration for the candidate cell.

In some embodiments, the circuitry may be configured to apply the configuration by: generating a first configuration based on the reference configuration and the configuration for the candidate cell; and applying the first configuration for the candidate cell.

In some embodiments, the circuitry may be further configured to: generate a set of second configurations for the set of candidate cells based on the reference configuration and the set of configurations for the set of candidate cells; and store the set of second configurations. In these embodiments, the circuitry may be configured to apply the configuration by applying a stored second configuration for the candidate cell.

In some embodiments, a terminal device comprises a circuitry configured to: receive, from a first network device, a set of configurations for a set of candidate cells; and in accordance with a determination that a cell change or addition to a candidate cell in the set of candidate cells is to be performed, apply a configuration for the candidate cell in the set of configurations, wherein the configuration for the candidate cell is the same as a configuration of a cell group serving the terminal device or a configuration for a further candidate cell in the set of candidate cells, except for at least one of the following: an identity for a candidate cell in the set of candidate cells; a timer for a candidate cell in the set of candidate cells; a dedicated random access channel configuration for a candidate cell in the set of candidate cells; or a measurement configuration of a candidate cell in the set of candidate cells.

In some embodiments where the configuration for the candidate cell is the same as the configuration for the further candidate cell in the set of candidate cells, the circuitry may be configured to apply the configuration by: receiving, from the first network device, an indication indicating the further candidate cell; and applying the configuration for the candidate cell based on the indication.

In some embodiments, a terminal device comprises a circuitry configured to: receive, from a first network device, a set of full configurations for a set of candidate cells; and in accordance with a determination that a cell change or addition to a candidate cell in the set of candidate cells is to be performed, apply a configuration for the candidate cell in the set of full configurations.

In some embodiments, the circuitry may be configured to apply the configuration by: in accordance with a determination that at least one execution condition for the candidate cell is fulfilled, applying the configuration for the candidate cell.

In some embodiments, the circuitry may be configured to apply the configuration by: in accordance with a determination that a lower layer signaling is received, applying the configuration for the candidate cell.

In some embodiments where the configuration comprises a dedicated random access configuration for the candidate cell, the circuitry may be further configured to: perform a cell change or addition to the candidate cell based on the dedicated random access configuration; and in accordance with a determination that a further cell change to the candidate cell is to be performed, perform the further cell change without using the dedicated random access configuration.

In some embodiments where the configuration comprises a dedicated random access configuration for a cell change or addition and a timer configured for the candidate cell, the circuitry may be further configured to: in accordance with a determination that the configuration is received, start the timer; and in accordance with a determination that the timer expires, release the dedicated random access configuration.

In some embodiments, the circuitry may be further configured to perform a cell change or cell addition to the candidate cell only based on a contention based random access procedure.

In some embodiments, a network device comprises a circuitry configured to: transmit, to a terminal device, a set of configurations for a set of candidate cells, and an indication indicating a configuration for one of a set of candidate cells as a reference configuration.

In some embodiments, the circuitry may be further configured to: transmit the configuration for the one of the set of candidate cells to a set of second network devices providing the set of candidate cells; and receive, from the set of second network devices, the set of configurations generated based on the configuration for the one candidate cell as the reference configuration.

In some embodiments, a network device comprises a circuitry configured to: transmit, to a terminal device, a set of configurations for a set of candidate cells, wherein a configuration for a candidate cell in the set of candidate cells is the same as a configuration of a cell group serving the terminal device or a configuration for a further candidate cell in the set of candidate cells, except for at least one of the following: an identity for a candidate cell in the set of candidate cells; a timer for a candidate cell in the set of candidate cells; a dedicated random access channel configuration for a candidate cell in the set of candidate cells; or a measurement configuration of a candidate cell in the set of candidate cells.

In some embodiments, the circuitry may be further configured to receive the set of configurations from a set of second network devices providing the set of candidate cells.

In some embodiments where the configuration for the candidate cell is the same as the configuration for the further candidate cell in the set of candidate cells, the circuitry may be further configured to transmit, to the terminal device, an indication indicating the further candidate cell.

In some embodiments, a network device comprises a circuitry configured to: transmit, to a terminal device, a set of configurations for a set of candidate cells, a configuration in the set of configurations being a full configuration for a candidate cell.

In some embodiments, the circuitry may be further configured to receive the set of full configurations from a set of second network devices providing the set of candidate cells.

In some embodiments, the configuration for the candidate cell comprises a dedicated random access configuration for a candidate cell in the set of candidate cells. In some embodiments, the configuration for the candidate cell comprises a dedicated random access configuration for the cell change or addition and a timer configured for a candidate cell in the set of candidate cells. In some embodiments, the configuration for the candidate cell comprises no dedicated random access configuration for the set of candidate cells.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-29. (canceled)

30. A method of a User Equipment (UE), the method comprising:
receiving, from a network, a Radio Resource Control (RRC) Reconfiguration message which includes a first configuration associated with a candidate cell for L1/L2 Triggered Mobility; and
applying the first configuration in a case where a cell switch is triggered by an indication from a lower layer.

31. The method according to claim 30,
wherein the first configuration is a complete candidate configuration or a delta configuration relative to a reference configuration, and
wherein the method further comprises:
considering the reference configuration to be a current UE configuration in a case where the first configuration is not the complete candidate configuration.

32. The method according to claim 30,
wherein the first configuration is a candidate configuration.

33. A method of a User Equipment (UE), the method comprising:
receiving, from a network, a Radio Resource Control (RRC) Reconfiguration message which includes a first configuration associated with a candidate cell for a subsequent Conditional PSCell Addition or Change; and
applying the first configuration in a case where an execution condition of a candidate PSCell is satisfied.

34. The method according to claim 33,
wherein the first configuration is a complete candidate configuration or a delta configuration relative to a reference configuration, and
wherein the method further comprises:
considering the reference configuration to be a current UE configuration in a case where the first configuration is not the complete candidate configuration.

35. The method according to claim 34, further comprising:
storing the reference configuration within a UE variable.

36. The method according to claim 34, further comprising:
replacing the reference configuration within a UE variable.

37. The method according to claim 33,
wherein the first configuration is a candidate configuration.

38. A User Equipment (UE) comprising:
a memory; and
a processor coupled with the memory, wherein the processor is configured to:
receive, from a network, a Radio Resource Control (RRC) Reconfiguration message which includes a first configuration associated with a candidate cell for L1/L2 Triggered Mobility, and
apply the first configuration in a case where a cell switch is triggered by an indication from a lower layer.

39. The UE according to claim 38,
wherein the first configuration is a complete candidate configuration or a delta configuration relative to a reference configuration, and
wherein the processor is configured to:
consider the reference configuration to be a current UE configuration in a case where the first configuration is not the complete candidate configuration.

40. The UE according to claim 38,
wherein the first configuration is a candidate configuration.

41. A User Equipment (UE) comprising:
a memory; and
a processor coupled with the memory, wherein the processor is configured to:
receive, from a network, a Radio Resource Control (RRC) Reconfiguration message which includes a first configuration associated with a candidate cell for a subsequent Conditional PSCell Addition or Change, and
apply the first configuration in a case where an execution condition of a candidate PSCell is satisfied.

42. The UE according to claim 41,
wherein the first configuration is a complete candidate configuration or a delta configuration relative to a reference configuration, and
wherein the processor is configured to:
consider the reference configuration to be a current UE configuration in a case where the first configuration is not the complete candidate configuration.

43. The UE according to claim 42, further comprising:
storing the reference configuration within a UE variable.

44. The UE according to claim 42, further comprising:
replacing the reference configuration within a UE variable.

45. The UE according to claim 41,
wherein the first configuration is a candidate configuration.
